(19) United States
(12) Patent Application Publication
(10) Pub. No.: US 2015/0302822 A1
(43) Pub. Date: Oct. 22, 2015

(54) DISPLAY DRIVER IC AND DISPLAY SYSTEM INCLUDING THE SAME

(71) Applicant: Samsung Electronics Co., Ltd., Suwon-Si (KR)

(72) Inventors: Ha Jun LEE, Seoul (KR); Myung Ho SEO, Hwaseong-si (KR); Jin Han KIM, Suwon-si (KR); Suk Yun WOO, Seoul (KR); Seong Jong YOO, Seongnam-si (KR)

(21) Appl. No.: 14/618,333

(22) Filed: Feb. 10, 2015

(30) Foreign Application Priority Data
Apr. 18, 2014 (KR) 10-2014-0046377

(51) Int. Cl. G09G 5/00

(52) U.S. Cl. CPC G09G 5/006; G09G 2370/08; G09G 2330/06; G09G 2310/08

(57) ABSTRACT

A display driver integrated circuit (IC) includes a first driver block, a second driver block, and a transmission control circuit. The transmission control circuit is configured to deserialize pixel data groups of a serial data packet and to alternate sending the deserialized pixel data groups to the first driver block and the second driver block. Each of the pixel data groups includes pixel data for at least one pixel.

### CROSS-REFERENCE TO RELATED APPLICATIONS

This application claims priority under 35 U.S.C. §119(a) from Korean Patent Application No. 10-2014-0046377 filed on Apr. 18, 2014, the disclosure of which is hereby incorporated by reference in its entirety.

### BACKGROUND

At least one example embodiment of the inventive concepts relates to a display driver integrated circuit (IC), and more particularly, to a display driver IC for outputting each of a plurality of deserialized pixel data groups alternately to each of a plurality of driver blocks and/or a display system including the same.

In a display system including a display driver IC and a display, the data rate of a receiving interface included in the display driver IC increases as the frame rate of the display, the resolution of the display, and/or the amount of a three-dimensional (3D) image displayed on the display increases.

As the data rate increases, an open eye of an eye pattern of data deserialized by the receiving interface decreases.

Moreover, as the data rate increases, the width of the data decreases and the size of a driver driving the data increases.

When the width of data decreases, the setup time and the hold time between the data and a clock signal used to process the data also decreases. As a result, the display driver IC may have difficulty in accurately processing the data.

In addition, when the size of the driver (which is included in the display driver IC to drive a data line of the display) increases, the driver consumes increased power and current peak increases. When the current peak increases, electromagnetic interference (EMI) may also increase.

### SUMMARY

At least one example embodiment of the inventive concepts provide a display driver integrated circuit (IC) for reducing electromagnetic interference (EMI) at a high data rate without increasing the current peak and/or a display system including the same.

According to at least one example embodiment, a display driver integrated circuit (IC) includes a first driver block, a second driver block, and a transmission control circuit. The transmission control circuit is configured to deserialize pixel data groups of a serial data packet and to alternate sending the deserialized pixel data groups to the first driver block and the second driver block. Each of the pixel data groups includes pixel data for at least one pixel.

According to at least one example embodiment, the transmission control circuit is configured to send a first one of the deserialized pixel data groups to one of the first driver block and the second driver block based on a control signal.

According to at least one example embodiment, the transmission control circuit is configured to generate the control signal based on configuration information in the serial data packet.

According to at least one example embodiment, the transmission control circuit is configured to generate the control signal based on a level of a control pin of the display driver IC.

According to at least one example embodiment, the display driver IC further includes a first latch signal generator configured to generate first latch signals based on a first latch control signal. The display driver IC further includes a second latch signal generator configured to generate second latch signals based on a second latch control signal. First latches included in the first driver block are configured to latch corresponding ones of the deserialized pixel data groups in response to the first latch signals. Second latches included in the second driver block are configured to latch corresponding ones of the deserialized pixel data groups in response to the second latch signals. The first latch signal generator and the second latch signal generator are configured to alternately generate the first latch signals and the second latch signals.

According to at least one example embodiment, the transmission control circuit is configured to generate the first and second latch control signals based on configuration information included in the serial data packet.

According to at least one example embodiment, the transmission control circuit is configured to generate the first and second latch control signals based on a level of a control pin of the display driver IC.

According to at least one example embodiment, a display system includes a timing controller, and a display driver integrated circuit (IC). The timing controller includes a transmission and high-speed interface block configured to generate a serial data packet having configuration information and pixel data groups and to transmit the serial data packet to the display driver IC. The configuration information indicates an order of the pixel data groups. Each of the pixel data groups including pixel data for at least one pixel.

According to at least one example embodiment, the display driver IC includes a first driver block, a second driver block, and a transmission control circuit. The transmission control circuit is configured to deserialize the pixel data groups of the serial data packet and to alternate sending the deserialized pixel data groups to the first driver block and the second driver block based on a control signal associated with the configuration information.

According to at least one example embodiment, the transmission control circuit is configured to send a first one of the deserialized pixel data groups to one of the first driver block and the second driver block based on the control signal.

According to at least one example embodiment, the display system includes a first latch signal generator configured to generate first latch signals based on a first latch control signal. The display system includes a second latch signal generator configured to generate second latch signals based on a second latch control signal. First latches included in the first driver block are configured to latch a corresponding one of the deserialized pixel data groups in response to the first latch signals. Second latches included in the second driver block are configured to latch a corresponding one of the deserialized pixel data groups in response to the second latch signals. The first latch signal generator and the second latch signal generator are configured to alternately generate the first latch signals and the second latch signals.

According to at least one example embodiment, the transmission control circuit is configured to generate the first and second control signals based on the control signal associated with the configuration information.

According to at least one example embodiment, the first latch signal generator is configured to generate one of the first latch signals before one of the second latch signals is generated.

According to at least one example embodiment, the first latch signal generator is configured to generate one of the first latch signals after one of the second latch signals is generated.

According to at least one example embodiment, the timing controller and the display driver IC are included in one of a television (TV), a digital TV (DTV), an internet protocol TV (IPTV), and a smart TV.

According to at least one example embodiment, a display device includes a controller configured to process pixel data groups of a received data packet in a desired order that changes based on a mode of the display device, each of the pixel data groups including pixel data for at least one pixel. The controller may be configured to output the processed pixel data groups from a first driver block and a second driver block in accordance with the desired order.

According to at least one example embodiment, the controller includes a control pin that indicates the mode.

According to at least one example embodiment, the pixel data includes configuration information to indicate the mode.

According to at least one example embodiment, each of the pixel data groups includes pixel data for a plurality of pixels.

According to at least one example embodiment, if the mode is a high speed mode, the desired order is such that the controller is configured to alternately output the pixel data groups to the first driver block and the second driver block.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a schematic block diagram of a display system according to at least one example embodiment of the inventive concepts;

FIGS. 2A and 2B are timing charts showing the types of data packets transmitted from the display system illustrated in FIG. 1;

FIG. 3 is a schematic block diagram of a display system according to at least one example embodiment of the inventive concepts;

FIGS. 4A and 4B are timing charts showing the types of data packets transmitted from the display system illustrated in FIG. 3;

FIG. 5 is a schematic block diagram of a display driver integrated circuit (IC) included in the display system illustrated in FIG. 1 or 3 according to at least one example embodiment of the inventive concepts;

FIG. 6 is a detailed block diagram of the display driver IC illustrated in FIG. 5;

FIG. 7 is a timing chart for explaining operation of the display driver IC illustrated in FIG. 5 according to at least one example embodiment of the inventive concepts;

FIG. 8 is a specified example of the timing chart illustrated in FIG. 6;

FIG. 9 is a timing chart for explaining operation of the display driver IC illustrated in FIG. 5 according to at least one example embodiment of the inventive concepts;

FIG. 10 is a timing chart for explaining operation of the display driver IC illustrated in FIG. 5 according to at least one example embodiment of the inventive concepts;

FIG. 11 is a schematic block diagram of a display driver IC included in the display system illustrated in FIG. 1 or 3 according to at least one example embodiment of the inventive concepts; and

FIG. 12 is a flowchart of a method of operating a display driver IC included in the display system illustrated in FIG. 1 or 3 according to at least one example embodiment of the inventive concepts.

### DETAILED DESCRIPTION OF EXAMPLE EMBODIMENTS

Inventive concepts will now be described more fully with reference to the accompanying drawings, in which example embodiments of are shown. These example embodiments are provided so that this disclosure will be thorough and complete, and will fully convey inventive concepts of to those skilled in the art. Inventive concepts may be embodied in many different forms with a variety of modifications, and a few embodiments will be illustrated in drawings and explained in detail. However, this should not be construed as being limited to example embodiments set forth herein, and rather, it should be understood that changes may be made in these example embodiments without departing from the principles and spirit of inventive concepts, the scope of which are defined in the claims and their equivalents. Like numbers refer to like elements throughout. In the drawings, the thicknesses of layers and regions are exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

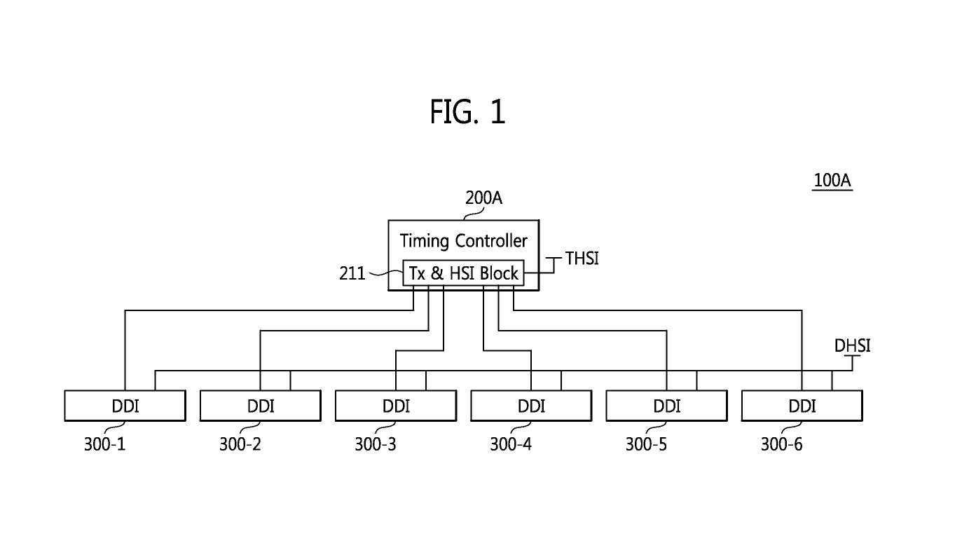

FIG. 1 is a schematic block diagram of a display system 100A according to at least one example embodiment of inventive concepts. The display system 100A includes a timing controller 200A and a plurality of display driver ICs (DDIs) 300-1 through 300-6.

The timing controller 200A and the DDIs 300-1 through 300-6 together may be mounted on a single board or a single display module. The display module may include a display.

The display driven by the DDIs 300-1 through 300-6 may be implemented as a thin film transistor-liquid crystal display (TFT-LCD), a light-emitting diode (LED) display, an organic LED (OLED) display, an active-matrix OLED (AMOLED) display, or a flexible display.

Although six DDIs 300-1 through 300-6 are illustrated in FIG. 1 for clarity of the description, the inventive concepts are not restricted to the number of DDIs included in the display system 100A.

The timing controller 200A may include a transmission and high-speed interface (Tx & HSI) block 211 and a first control pin THSI.

The timing controller 200A may transmit a data packet to the DDIs 300-1 through 300-6 through high-speed serial interface.

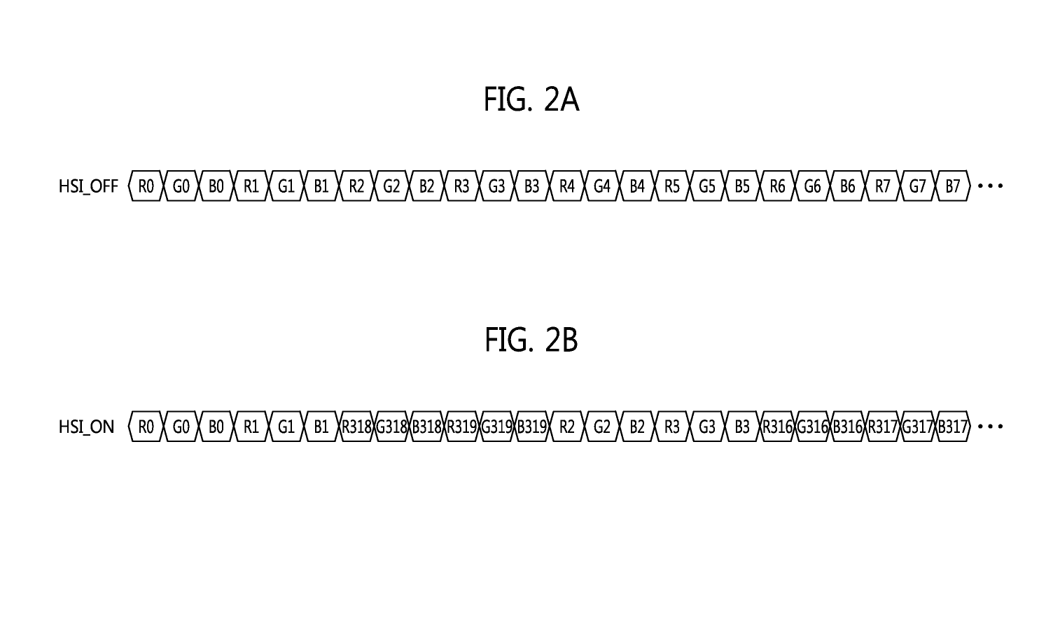

FIGS. 2A and 2B are timing charts showing the types of data packets transmitted from the display system 100A illustrated in FIG. 1.

For clarity of the description, data packets for a 960-channel configuration are illustrated in FIGS. 2A and 2B. For instance, the number of channels may be the number of data lines in a display. Pixel data may be 8, 10 or 12 bits in length.

The data packets illustrated in FIGS. 2A and 2B include pixel data groups output in units of two pixels. However, each pixel data group may include one or more pixel data items (or pixel data for at least one pixel).

For instance, pixel data Ri, Gi, and Bi (e.g., i=0 through 318) is data output from a first pixel and pixel data Ri+1, Gi+1, and Bi+1 is data output from a second pixel. Here, R indicates red pixel data, G indicates green pixel data, and B indicates blue pixel data. Thus, each pixel data group may include pixel data for a plurality of pixels.

Referring to FIG. 1 and FIGS. 2A and 2B, the order of pixel data included in a data packet may be determined according to the level of the first control pin THSI (or mode of the system 100A such as a normal mode or a high speed mode).

For instance, when the level of the first control pin THSI is an off level HSI_OFF (or the system 100A is in the normal mode), the Tx & HSI block 211 outputs a data packet including pixel data output in order shown in FIG. 2A.

However, when the level of the first control pin THSI is an on-level HSI_ON (or the system 100A is in the high speed mode), the Tx & HSI block 211 outputs a data packet including pixel data output in order shown in FIG. 2B.

Here, the off level HSI_OFF is one between a high level and a low level and the on-level HSI_ON is the other between the high level and the low level.

In at least one example embodiment, the level input to the first control pin THSI may be determined according to which one of a ground and a power line the first control pin THSI is connected to.

In at least one other example embodiment, the level input to the first control pin THSI may be determined using a particular configuration circuit (not shown).

A data packet output from the timing controller 200A may be transmitted to the DDIs 300-1 through 300-6 through a high-speed serial interface.

Each of the DDIs 300-1 through 300-6 may include a second control pin DHSI. A deserializing (or processing) method according to at least one example embodiment of the inventive concepts may be determined according to the level of the second control pin DHSI.

For instance, when the level of the second control pin DHSI is the off-level (or the system 100A is in the normal mode), the DDIs 300-1 through 300-6 may receive and deserialize (or process) the data packet illustrated in FIG. 2A. However, when the level of the second control pin DHSI is the on-level (or the system 100A is in the high speed mode), the DDIs 300-1 through 300-6 may receive and deserialize (or process) the data packet illustrated in FIG. 2B.

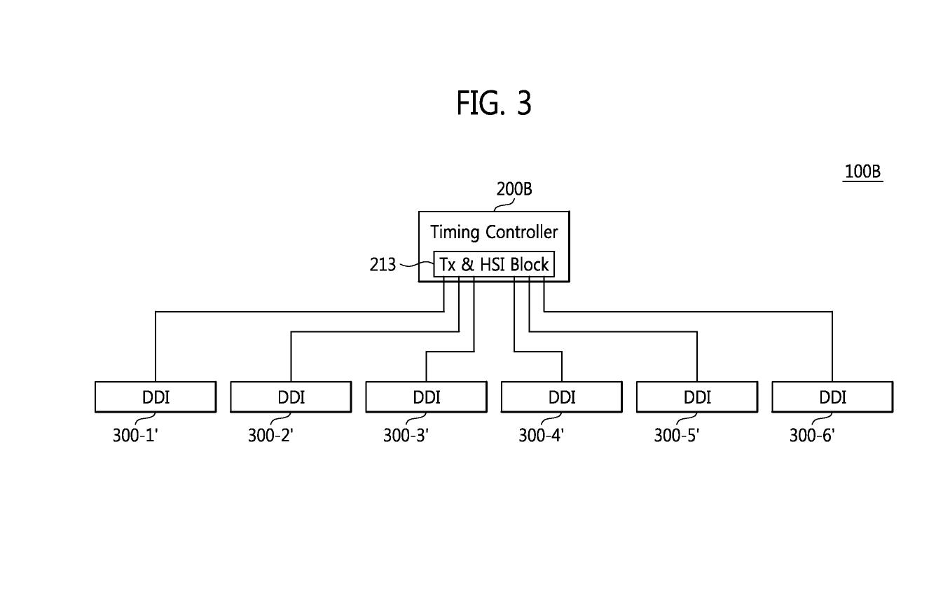

FIG. 3 is a schematic block diagram of a display system 100B according to at least one example of the inventive concepts. The display system 100B includes a timing controller 200B and DDIs 300-1′ through 300-6′.

The display system 100A or 100B may be implemented as a television (TV), a digital TV (DTV), an internet protocol TV (IPTV), or a smart TV. In at least one other example embodiment, the display system 100A or 100B may be implemented as a smart phone, a tablet personal computer (PC), or a mobile internet device (MID).

Referring to FIGS. 1 and 3, the timing controller 200B does not include the first control pin THSI and the DDIs 300-1′ through 300-6′ do not include the second control pin DHSI.

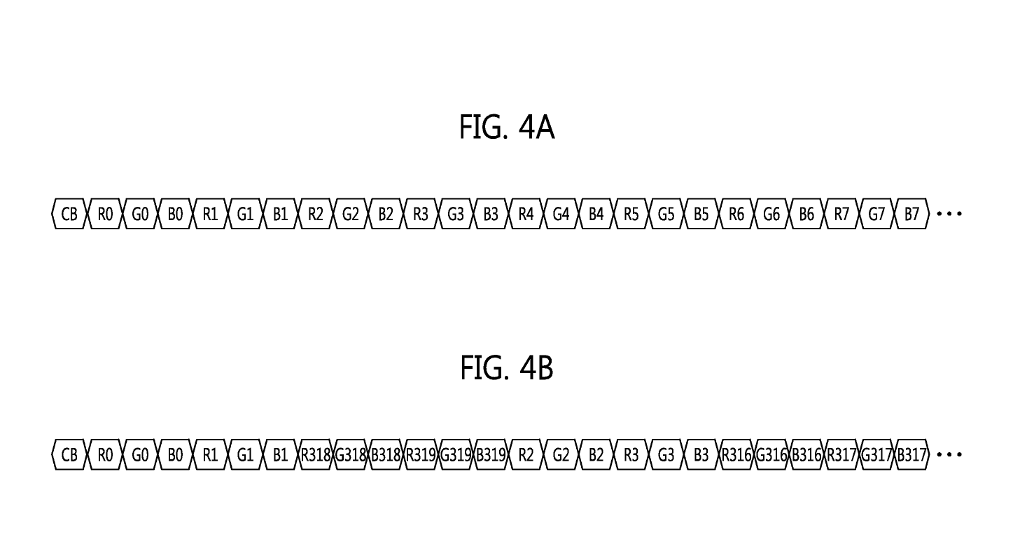

A Tx & HSI block 213 may generate a data packet including configuration information CB and pixel data. The DDIs 300-1′ through 300-6′ may identify whether a received data packet is the data packet illustrated in FIG. 4A or the data packet illustrated in FIG. 4B according to the configuration information CB. That is, the DDIs 300-1′ through 300-6′ may identify whether the system 100B is in a normal mode or a high speed mode.

Except for the configuration information CB, the data packet illustrated in FIG. 4A is substantially the same as that illustrated in FIG. 2A. Except for the configuration information CB, the data packet illustrated in FIG. 4B is substantially the same as that illustrated in FIG. 2B. Here, the configuration information CB may function as an indicator including one or more bits to indicate a normal mode or a high speed mode of the system 100B.

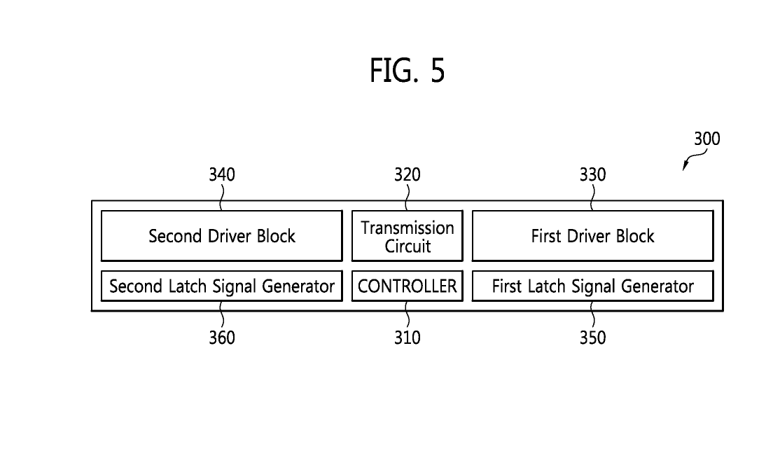

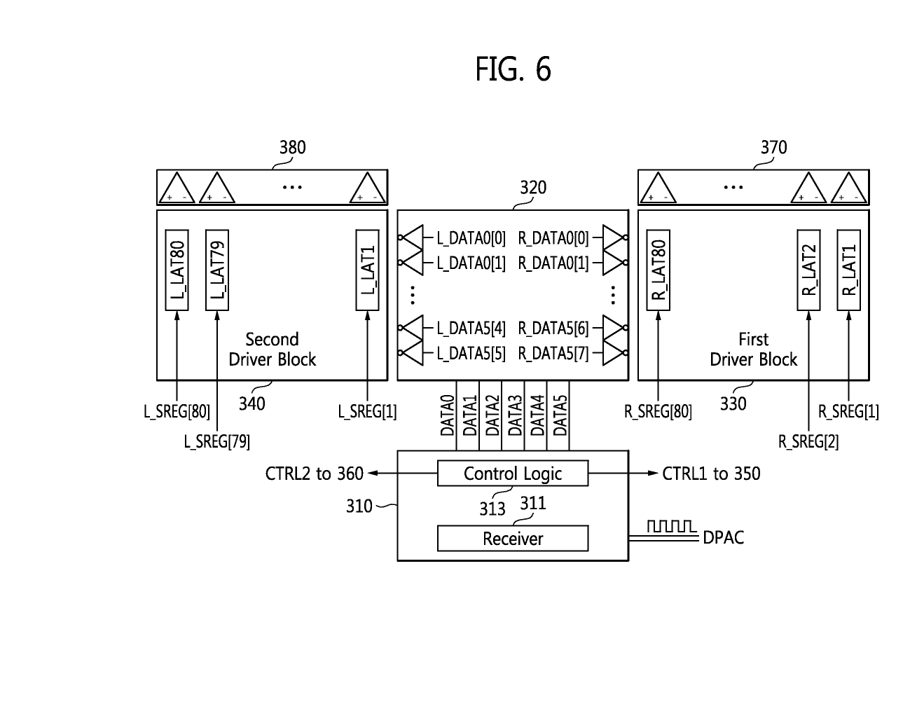

FIG. 5 is a schematic block diagram of a DDI 300 included in the display system 100A or 100B illustrated in FIG. 1 or 3 according to at least one example embodiment of the inventive concepts. FIG. 6 is a detailed block diagram of the DDI 300 illustrated in FIG. 5.

Referring to FIG. 5, the DDI 300 includes a controller 310, a transmission circuit 320, a first driver block 330, a second driver block 340, a first latch signal generator 350, and a second latch signal generator 360. As shown in FIG. 6, the DDI 300 may also include buffer blocks 370 and 380. The first driver block 330 and the second driver block 340 may be implemented symmetrically around the transmission circuit 320.

For clarity of the description, a 960-channel DDI, i.e., a 960-channel source driver IC chip is illustrated in FIG. 5. The DDI 300 is a representative of the DDIs 300-1 through 300-6 and 300-1′ through 300-6′.

The controller 310 receives and deserializes (or processes) a data packet including pixel data groups and transmits the deserialized (or processed) pixel data groups to the transmission circuit 320.

The transmission circuit 320 may transmit the current deserialized pixel data groups received from the controller 310 alternately to the first driver block 330 and the second driver block 340. The transmission circuit 320 may also control which of the first and second driver blocks 330 and 340 a first deserialized pixel data group will be transmitted to.

Therefore, the controller 310 and the transmission circuit 320 may perform a function as a transmission control circuit.

In at least one example embodiment, the controller 310 may control the operation of the first latch signal generator 350 and the operation of the second latch signal generator 360 using a first control signal CTRL1 and a second control signal CTRL2, respectively. The first and second control signals CTRL1 and CTRL3 may be generated based on the level of the second control pin DHSI explained with reference to FIG. 1.

In at least one example embodiment, the controller 310 may control the operation of the first latch signal generator 350 and the operation of the second latch signal generator 360 using the first control signal CTRL1 and the second control signal CTRL2, respectively. The first control signal CTRL1 and the second control signal CTRL2 may be generated according to the configuration information CB explained with reference to FIGS. 4A and 4B.

The first latch signal generator 350 may control the activation timing of each of first latch signals based on the first control signal CTRL1. Activation may indicate the transition from a low level to a high level or the transition from a high level to a low level.

When the first driver block 330 includes a plurality of first latches R_LAT1 through R_LAT80, the plurality of first latches R_LAT1 through R_LAT80 may latch a corresponding pixel data group in response to first latch signals R_SREG[1] through R_SREG[80], respectively.

The second latch signal generator 360 may control the activation timing of each of second latch signals based on the second control signal CTRL2.

When the second driver block 340 includes a plurality of second latches L_LAT1 through L_LAT80, the plurality of second latches L_LAT1 through L_LAT80 may latch a corresponding pixel data group in response to second latch signals L_SREG[1] through L_SREG[80], respectively.

Consequently, each of the latches R_LAT1 through R_LAT80 and L_LAT1 through L_LAT80 may latch at least one bit.

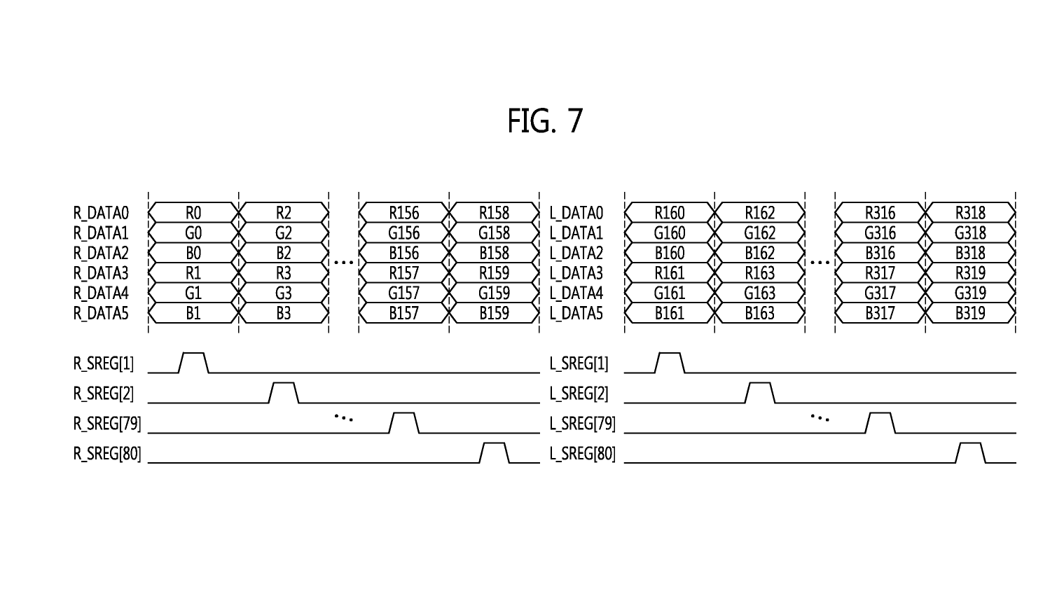

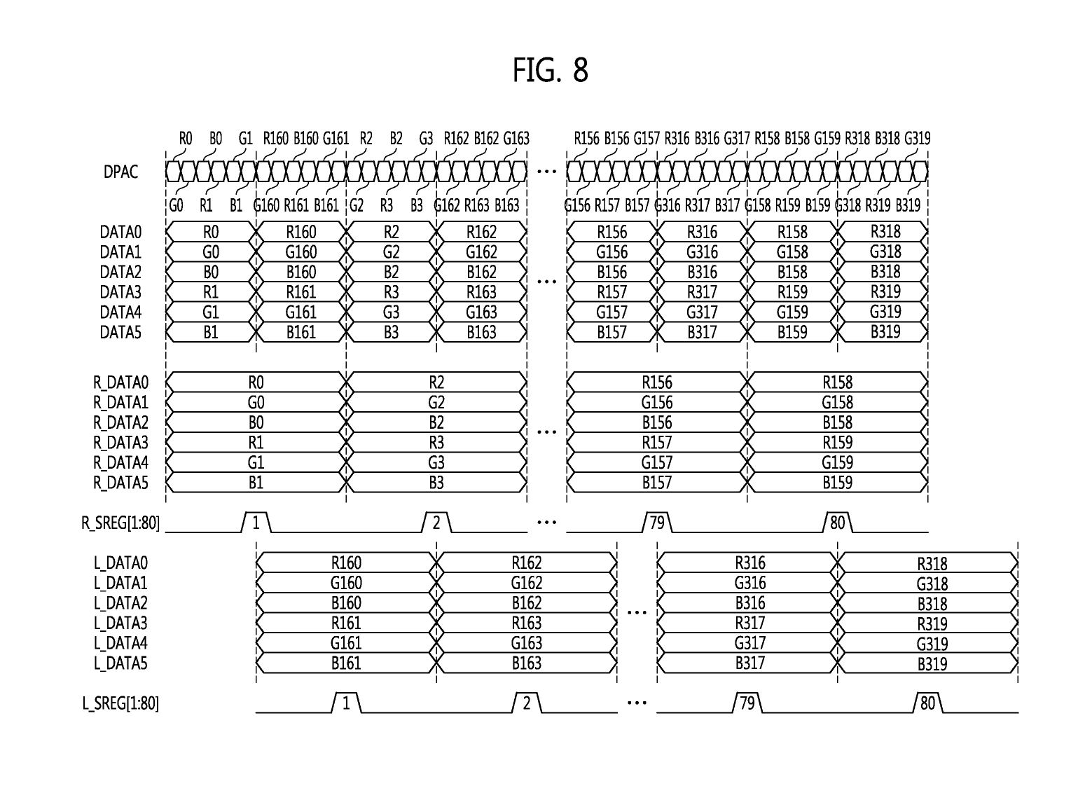

FIG. 7 is a timing chart for explaining operation of the DDI 300 illustrated in FIG. 5 according to at least one example embodiment of the inventive concepts. FIG. 8 is a specified example of the timing chart illustrated in FIG. 6.

Referring to FIGS. 5 through 8, a receiver 311 included in the controller 310 receives a data packet DPAC illustrated in FIG. 8 and sequentially deserializes (or processes) each of the pixel data groups included in the data packet DPAC. Consequently, the receiver 311 may function as a deserializer.

The receiver 311 deserializes a first pixel data group R0G0B0R1G1B1 included in the data packet DPAC and transmits the deserialized first pixel data group DATA[5:0] (=DATA0 through DATA5) to the transmission circuit 320.

The transmission circuit 320 transmits the deserialized first pixel data group DATA[5:0] to the first driver block 330.

At this time, the first latch signal generator 350 generates a pulse-type latch signal R_SREG[1] based on the first control signal CTRL1 output from a control logic 313. The latch R_LAT1 latches the deserialized first pixel data group DATA[5:0], i.e., R_DATA[5:0] (=R0G0B0R1G1B1) in response to the latch signal R_SREG[1].

Each of the latches R_LAT1 through R_LAT80 and L_LAT1 through L_LAT80 may latch a deserialized pixel data group in response to either a rising edge or a falling edge of one of the latch signals R_SREG[1] through R_SREG[80] and L_SREG[1] through L_SREG[80].

The deserialized first pixel data group that has been latched by one of the latches R_LAT1 through R_LAT80 and L_LAT1 through L_LAT80 may be transmitted to a data line of a display through a buffer included in one of the buffer blocks 370 and 380.

As described above, the control logic 313 may control the generation order or activation timing of the first and second control signals CTRL1 and CTRL2 based on the level of the second control pin DHSI or the configuration information CB.

The receiver 311 deserializes a second pixel data group R160G160B160R161G161B161 included in the data packet DPAC and transmits deserialized second pixel data group DATA[5:0] to the transmission circuit 320.

The transmission circuit 320 transmits the deserialized second pixel data group DATA[5:0] to the second driver block 340.

At this time, the second latch signal generator 360 generates the pulse-type latch signal L_SREG[1] based on the second control signal CTRL2 output from the control logic 313. The latch L_LAT1 latches the deserialized second pixel data group DATA[5:0], i.e., L_DATA[5:0] (=R160G160B160R161G161B161) in response to the latch signal L_SREG[1].

The receiver 311 deserializes a third pixel data group R2G2B2R3G3B3 included in the data packet DPAC and transmits deserialized third pixel data group DATA[5:0] to the transmission circuit 320.

The transmission circuit 320 transmits the deserialized third pixel data group DATA[5:0] to the first driver block 330.

At this time, the first latch signal generator 350 generates a pulse-type latch signal R_SREG[2]. The latch R_LAT2 latches the deserialized third pixel data group DATA[5:0], i.e., R_DATA[5:0] (=R2G2B2R3G3B3) in response to the latch signal R_SREG[2].

The receiver 311 deserializes a fourth pixel data group R162G162B162R163G163B163 included in the data packet DPAC and transmits deserialized fourth pixel data group DATA[5:0] to the transmission circuit 320.

The transmission circuit 320 transmits the deserialized fourth pixel data group DATA[5:0] to the second driver block 340.

At this time, the second latch signal generator 360 generates a pulse-type latch signal L_SREG[2]. The latch L_LAT2 latches the deserialized fourth pixel data group DATA[5:0], i.e., L_DATA[5:0] (=R162G162B162R163G163B163) in response to the latch signal L_SREG[2].

The receiver 311 deserializes a 159th pixel data group R158G158B158R159G159B159 included in the data packet DPAC and transmits deserialized 159th pixel data group DATA[5:0] to the transmission circuit 320.

The transmission circuit 320 transmits the deserialized 159th pixel data group DATA[5:0] to the first driver block 330.

At this time, the first latch signal generator 350 generates a pulse-type latch signal R_SREG[80]. The latch R_LAT80 latches the deserialized 159th pixel data group DATA[5:0], i.e., R DATA[5:0] (=R158G158B158R159G159B159) in response to the latch signal R_SREG[80].

The receiver 311 deserializes a 160th pixel data group R318G318B318R319G319B319 included in the data packet DPAC and transmits deserialized 160th pixel data group DATA[5:0] to the transmission circuit 320.

The transmission circuit 320 transmits the deserialized 160th pixel data group DATA[5:0] to the second driver block 340.

At this time, the second latch signal generator 360 generates a pulse-type latch signal L_SREG[80]. The latch L_LAT80 latches the deserialized 160th pixel data group DATA[5:0], i.e., L_DATA[5:0] (=R318G318B318R319G319B319) in response to the latch signal L_SREG[80].

In view of the above description, it may be said that the transmission circuit 320 transmits a pixel data group that has been serialized in an odd-numbered place (or position) to one of the first and second driver blocks 330 and 340 and transmits a pixel data group that has been serialized in an even-numbered place (or position) to the other of the first and second driver blocks 330 and 340 according to the control of the controller 310.

In view of the above, it may also be said that the DDI 300 may process pixel data groups of a received data packet in a desired order that changes based on a mode of the system (e.g., system 100A or 100B), and output the processed pixel data groups from the first driver block 330 and the second driver block 340 in accordance with the desired order. For example, if the mode is a high speed mode, the desired order is such that DDI 300 is configured to alternately output the pixel data groups to the first driver block 330 and the second driver block 340.

As shown in FIGS. 7 and 8, the first latch signals R_SREG, i.e., R_SREG[1] through R_SREG[80], are sequentially generated by the first latch signal generator 350 so that pixel data groups (e.g., odd-numbered pixel data groups) are sequentially latched from the right to the left and the second latch signals L_SREG, i.e., L_SREG[1] through L_SREG[80] are sequentially generated by the second latch signal generator 360 so that pixel data groups (e.g., even-numbered pixel data groups) are sequentially latched from the right to the left.

In other words, as shown in FIGS. 7 and 8, each of the first latch signals R_SREG[1] through R_SREG[80] and each of the second latch signals L_SREG[1] through L_SREG[80] are alternately generated. For instance, latch signals may be generated in order of R_SREG[1], L_SREG[1], R_SREG[2], L_SREG[2], . . . , R_SREG[79], L_SREG[79], R_SREG[80], and L_SREG[80].

In at least one example embodiment, the DDI 300 may be designed so that latch signals are generated in order of L_SREG[1], R_SREG[1], L_SREG[2], R_SREG[2], . . . , L_SREG[79], R_SREG[79], L_SREG[80], and R_SREG[80].

As has been described with reference to FIGS. 6 through 8, a first data bus for transmitting pixel data group to the first driver block 330 and a second data bus for transmitting pixel data group to the second driver block 340 may be separately provided.

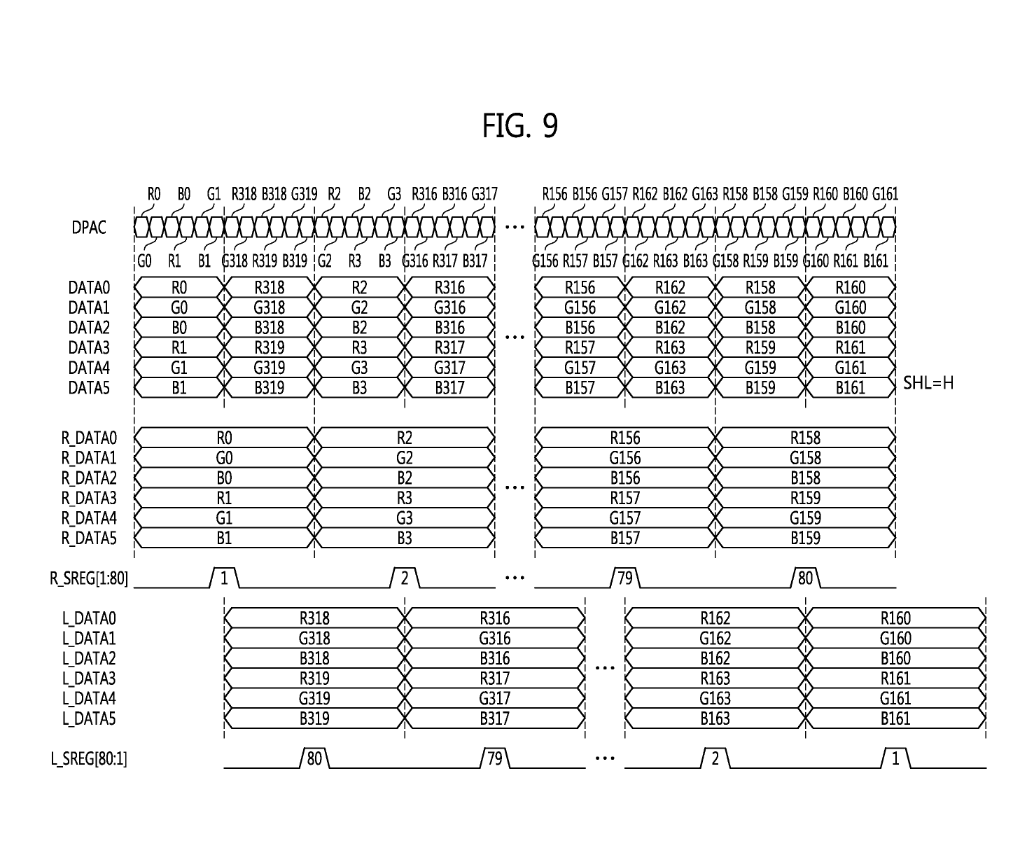

FIG. 9 is a timing chart for explaining operation of the DDI 300 illustrated in FIG. 5 according to at least one example embodiment of the inventive concepts.

Referring to FIGS. 5, 6, and 9, the order of pixel data groups included in the data packet DPAC may be decided by the timing controller 200A or 200B.

Referring to FIG. 9, the transmission circuit 320 transmits the pixel data group R0G0B0R1G1B1 that has been deserialized for the first time to the first driver block 330.

The control logic 313 may generate a transmission direction indicator signal in response to a transmission direction control signal SHL and may transmit the transmission direction indicator signal to the transmission circuit 320. The transmission circuit 320 may transmit a firstly deserialized pixel data group R0G0B0R1G1B1 to either the first driver block 330 or the second driver block 340 based on the transmission direction indicator signal.

In addition, the control logic 313 may generate the first and second control signals CTRL1 and CTRL2 in response to the transmission direction control signal SHL.

For instance, when the transmission direction control signal SHL is at a high level H, the transmission circuit 320 may transmit the firstly deserialized pixel data group R0G0B0R1G1B1 to the first driver block 330 based on a transmission direction indicator signal generated according to the transmission direction control signal SHL at the high level H.

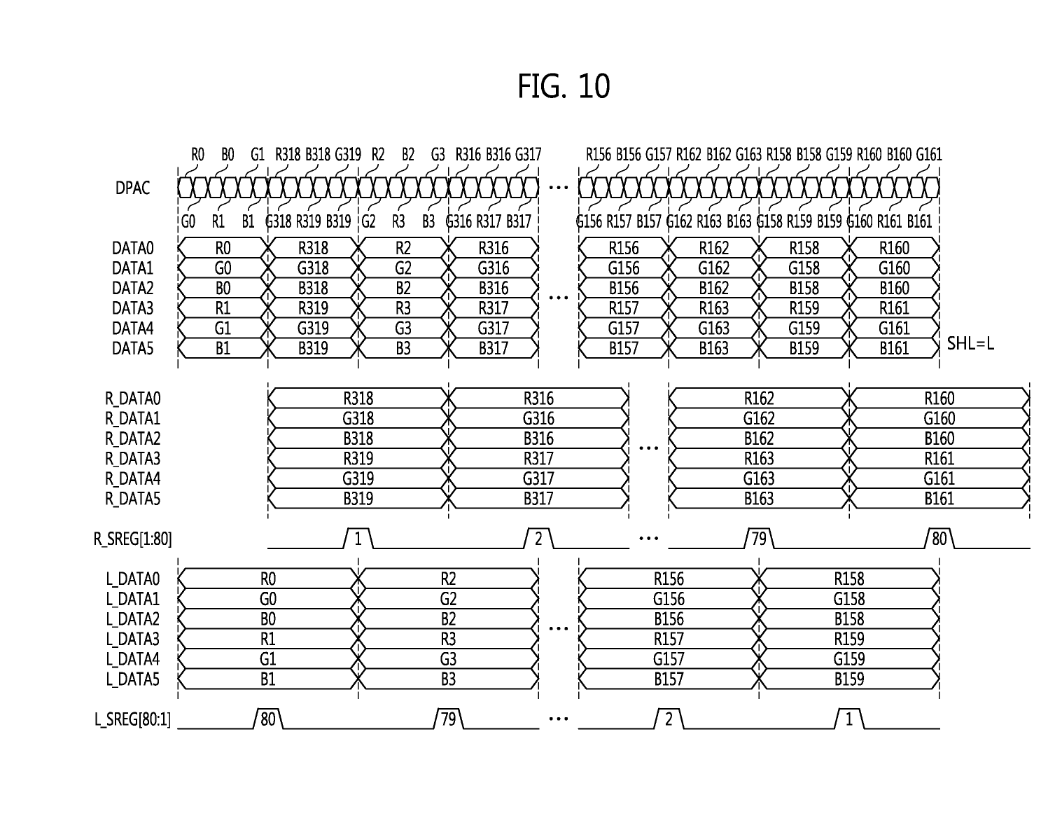

However, as shown in FIG. 10, when the transmission direction control signal SHL is at a low level L, the transmission circuit 320 may transmit the firstly deserialized pixel data group R0G0B0R1G1B1 to the second driver block 340 based on a transmission direction indicator signal generated according to the transmission direction control signal SHL at the low level L.

The first latch signals R_SREG[1] through R_SREG[80] illustrated in FIG. 7 are collectively represented by R_SREG[1:80] in FIGS. 8 through 10. The latch signal R_SREG[1] is generated first and the latch signal R_SREG[80] is generated last.

Similarly, the second latch signals L_SREG[1] through L_SREG[80] illustrated in FIG. 7 are collectively represented by L_SREG[1:80] in FIGS. 8 through 10. The latch signal L_SREG[1] is generated first and the latch signal L_SREG[80] is generated last.

Referring to FIGS. 5, 6, and 9, the receiver 311 deserializes a first pixel data group R0G0B0R1G1B1 included in the data packet DPAC and transmits a deserialized first pixel data group DATA[5:0] to the transmission circuit 320.

The transmission circuit 320 transmits the deserialized first pixel data group DATA[5:0] to the first driver block 330.

The first latch signal generator 350 generates the pulse-type latch signal R_SREG[1] based on the first control signal CTRL1 output from the control logic 313. The latch R_LAT1 latches the deserialized first pixel data group DATA[5:0], i.e., R_DATA[5:0] (=R0G0B0R1G1B1), in response to the latch signal R_SREG[1].

Then, the receiver 311 deserializes a second pixel data group R318G318B318R319G319B319 included in the data packet DPAC and transmits deserialized second pixel data group DATA[5:0] to the transmission circuit 320.

The transmission circuit 320 transmits the deserialized second pixel data group DATA[5:0] to the second driver block 340.

The second latch signal generator 360 generates the pulse-type latch signal L_SREG[80] based on the second control signal CTRL2 output from the control logic 313.

The latch L_LAT80 latches the deserialized second pixel data group DATA[5:0], i.e., L_DATA[5:0] (=R318G318B318R319G319B319), in response to the latch signal L_SREG[80].

Then, the receiver 311 deserializes a third pixel data group R2G2B2R3G3B3 included in the data packet DPAC and transmits deserialized third pixel data group DATA[5:0] to the transmission circuit 320.

The transmission circuit 320 transmits the deserialized third pixel data group DATA[5:0] to the first driver block 330.

The first latch signal generator 350 generates the pulse-type latch signal R_SREG[2]. The latch R_LAT2 latches the deserialized third pixel data group DATA[5:0], i.e., R_DATA[5:0] (=R2G2B2R3G3B3), in response to the latch signal R_SREG[2].

Then, the receiver 311 deserializes a fourth pixel data group R316G316B316R317G317B317 included in the data packet DPAC and transmits deserialized fourth pixel data group DATA[5:0] to the transmission circuit 320.

The transmission circuit 320 transmits the deserialized fourth pixel data group DATA[5:0] to the second driver block 340. The second latch signal generator 360 generates the pulse-type latch signal L_SREG[79]. The latch L_LAT79 latches the deserialized fourth pixel data group DATA[5:0] , i.e., L_DATA[5:0] (=R316G316B316R317G317B317), in response to the latch signal L_SREG[79].

Then, the receiver 311 deserializes a 159th pixel data group R158G158B158R159G159B159 included in the data packet DPAC and transmits deserialized 159th pixel data group DATA[5:0] to the transmission circuit 320.

The transmission circuit 320 transmits the deserialized 159th pixel data group DATA[5:0] to the first driver block 330.

The first latch signal generator 350 generates the pulse-type latch signal R_SREG[80]. The latch R_LAT80 latches the deserialized 159th pixel data group DATA[5:0], i.e., R_DATA[5:0] (=R158G158B158R159G159B159), in response to the latch signal R_SREG[80].

Then, the receiver 311 deserializes a 160th pixel data group R160G160B160R161G161B161 included in the data packet DPAC and transmits deserialized 160th pixel data group DATA[5:0] to the transmission circuit 320.

The transmission circuit 320 transmits the deserialized 160th pixel data group DATA[5:0] to the second driver block 340.

The second latch signal generator 360 generates the pulse-type latch signal L_SREG[1]. The latch L_LAT1 latches the deserialized 160th pixel data group DATA[5:0], i.e., L_DATA[5:0] (=R160G160B160R161G161B161), in response to the latch signal L_SREG[1].

FIG. 10 is a timing chart for explaining operation of the DDI 300 illustrated in FIG. 5 according to at least one example embodiment of the inventive concepts.

Referring to FIG. 10, when the transmission direction control signal SHL is at the low level L, the transmission circuit 320 may transmit a firstly deserialized pixel data group R0G0B0R1G1B1 to the second driver block 340 based on a transmission direction indicator signal generated according to the transmission direction control signal SHL at the low level L.

The second latch signal generator 360 generates the pulse-type latch signal L_SREG[80] based on the second control signal CTRL2 output from the control logic 313. The latch L_LAT80 latches the deserialized first pixel data group DATA[5:0], i.e., L_DATA[5:0] (=R0G0B0R1G1B1), in response to the latch signal L_SREG[80].

The receiver 311 deserializes a second pixel data group R318G318B318R319G319B319 included in the data packet DPAC and transmits deserialized second pixel data group DATA[5:0] to the transmission circuit 320.

The transmission circuit 320 transmits the deserialized second pixel data group DATA[5:0] to the first driver block 330.

The first latch signal generator 350 generates the pulse-type latch signal R_SREG[1] based on the first control signal CTRL1 output from the control logic 313. The latch R_LAT1 latches the deserialized second pixel data group DATA[5:0], i.e., R_DATA[5:0] (=R318G318B318R319G319B319), in response to the latch signal R_SREG[1].

The receiver 311 deserializes a third pixel data group R2G2B2R3G3B3 included in the data packet DPAC and transmits deserialized third pixel data group DATA[5:0] to the transmission circuit 320.

The transmission circuit 320 transmits the deserialized third pixel data group DATA[5:0] to the second driver block 340.

The second latch signal generator 360 generates the pulse-type latch signal L_SREG[79]. The latch L_LAT79 latches the deserialized third pixel data group DATA[5:0], i.e., L_DATA[5:0] (=R2G2B2R3G3B3), in response to the latch signal L_SREG[79].

The receiver 311 deserializes a fourth pixel data group R316G316B316R317G317B317 included in the data packet DPAC and transmits deserialized fourth pixel data group DATA[5:0] to the transmission circuit 320.

The transmission circuit 320 transmits the deserialized fourth pixel data group DATA[5:0] to the first driver block 330.

The first latch signal generator 350 generates the pulse-type latch signal R_SREG[2]. The latch R_LAT2 latches the deserialized fourth pixel data group DATA[5:0], i.e., R_DATA[5:0] (=R316G316B316R317G317B317), in response to the latch signal R_SREG[2].

The receiver 311 deserializes a 159th pixel data group R158G158B158R159G159B159 included in the data packet DPAC and transmits deserialized 159th pixel data group DATA[5:0] to the transmission circuit 320.

The transmission circuit 320 transmits the deserialized 159th pixel data group DATA[5:0] to the second driver block 340.

The second latch signal generator 360 generates the pulse-type latch signal L_SREG[1]. The latch L_LAT1 latches the deserialized 159th pixel data group DATA[5:0], i.e., L_DATA[5:0] (=R158G158B158R159G159B159) in response to the latch signal L_SREG[1].

The receiver 311 deserializes a 160th pixel data group R160G160B160R161G161B161 included in the data packet DPAC and transmits deserialized 160th pixel data group DATA[5:0] to the transmission circuit 320.

The transmission circuit 320 transmits the deserialized 160th pixel data group DATA[5:0] to the first driver block 330.

The first latch signal generator 350 generates the pulse-type latch signal R_SREG[80]. The latch R_LAT80 latches the deserialized 160th pixel data group DATA[5:0], i.e., R_DATA[5:0] (=R160G160B160R161G161B161), in response to the latch signal R_SREG[80].

As described above, the DDI 300 outputs each of deserialized pixel data groups alternately to each of a plurality of driver blocks, so that a frequency of the DDI 300 to latch the pixel data groups is less than (e.g., half of) a frequency used by a conventional DDI to latch pixel data only in one direction.

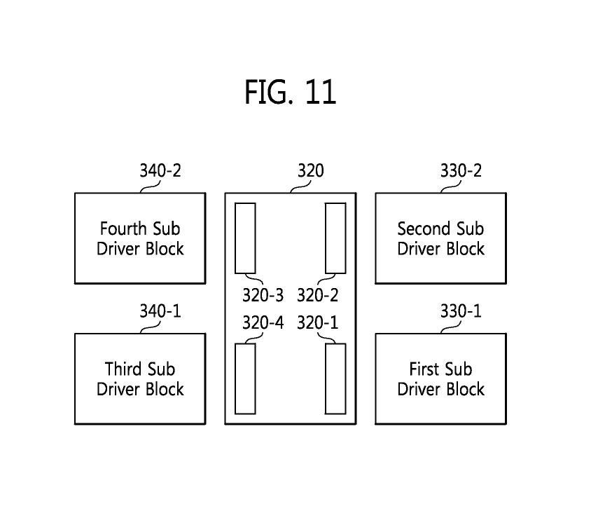

FIG. 11 is a schematic block diagram of a DDI included in the display system 100A or 100B illustrated in FIG. 1 or 3 according to at least one example embodiment of the inventive concepts.

Referring to FIG. 11, the DDI includes the transmission circuit 320, a first sub driver block 330-1, a second sub driver block 330-2, a third sub driver block 340-1, and a fourth sub driver block 340-2. The DDI may also include elements corresponding to the elements 310, 350, and 360 illustrated in FIG. 5. How each pixel data group is latched to one of the sub driver blocks 330-1, 330-2, 340-1, and 340-2 will be understood with reference to FIGS. 5 through 10.

A k-th pixel data group, e.g., a first pixel data group included in a data packet, is latched to the first sub driver block 330-1 through a first data bus 320-1 included in the transmission circuit 320, where “k” is a natural number of at least 1.

A (k+1)-th pixel data group, e.g., a second pixel data group included in the data, packet is latched to the second sub driver block 330-2 through a second data bus 320-2 included in the transmission circuit 320.

A (k+2)-th pixel data group, e.g., a third pixel data group included in the data packet, is latched to the fourth sub driver block 340-2 through a third data bus 320-3 included in the transmission circuit 320.

A (k+3)-th pixel data group, e.g., a fourth pixel data group included in the data packet, is latched to the third sub driver block 340-1 through a fourth data bus 320-4 included in the transmission circuit 320.

In at least one example embodiment, the k-th pixel data group, e.g., the first pixel data group included in a data packet is latched to the third sub driver block 340-1 through the fourth data bus 320-4 included in the transmission circuit 320.

The (k+1)-th pixel data group, e.g., the second pixel data group included in the data packet, is latched to the fourth sub driver block 340-2 through the third data bus 320-3 included in the transmission circuit 320.

The (k+2)-th pixel data group, e.g., the third pixel data group included in the data packet, is latched to the second sub driver block 330-2 through the second data bus 320-2 included in the transmission circuit 320.

The (k+3)-th pixel data group, e.g., the fourth pixel data group included in the data packet, is latched to the first sub driver block 330-1 through the first data bus 320-1 included in the transmission circuit 320.

A frequency of the DDI according to an example embodiment illustrated in FIG. 11 to latch the pixel data groups is ¼ of a frequency used by a conventional DDI to latch pixel data only in one direction.

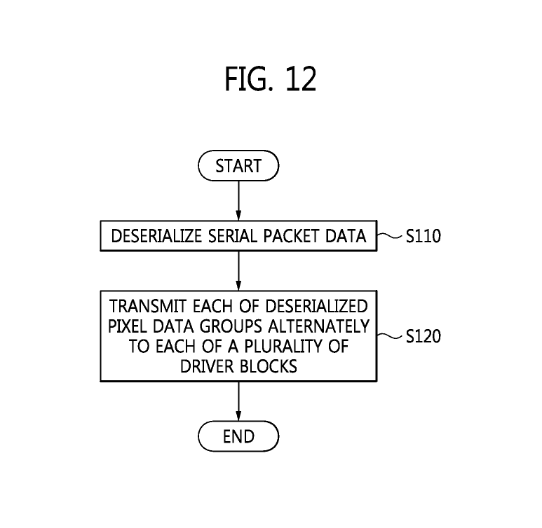

FIG. 12 is a flowchart of a method of operating a DDI included in the display system 100A or 100B illustrated in FIG. 1 or 3 according to at least one example embodiment of the inventive concepts.

Referring to FIGS. 1 through 12, the DDI may deserialize a serial data packet including a plurality of pixel data groups into the pixel data groups in operation S110 and transmit (or send) each of the deserialized pixel data groups alternately to each of a plurality of driver blocks or a plurality of sub driver blocks in operation S120. A sub driver block performs the same function as a driver block in at least one other example embodiment, and therefore, the driver block may be considered as including the sub driver block.

As described above, according to at least one example embodiment of the inventive concepts, a DDI outputs each of a plurality of deserialized pixel data groups alternately to each of a plurality of driver blocks, thereby reducing a frequency of a latch signal as compared to a conventional DDI that latches data only in one direction. In addition, according to at least one example embodiment of the inventive concepts, the DDI controls the driver blocks independently. Furthermore, the DDI reduces the size of a driver, which is included in the DDI, while maintaining a high-speed data rate. As the size of the driver is reduced, the current peak of the driver is decreased. As a result, electromagnetic interference (EMI) is decreased.

While the inventive concepts have been particularly shown and described with reference to example embodiments thereof, it will be understood by those of ordinary skill in the art that various changes in forms and details may be made therein without departing from the spirit and scope of the inventive concepts as defined by the following claims.

What is claimed is:

1. A display driver integrated circuit (IC) comprising:
a first driver block;
a second driver block; and
a transmission control circuit configured to deserialize pixel data groups of a serial data packet and to alternate sending the deserialized pixel data groups to the first driver block and the second driver block, each of the pixel data groups including pixel data for at least one pixel.

2. The display driver IC of claim 1, wherein the transmission control circuit is configured to send a first one of the deserialized pixel data groups to one of the first driver block and the second driver block based on a control signal.

3. The display driver IC of claim 2, wherein the transmission control circuit is configured to generate the control signal based on configuration information in the serial data packet.

4. The display driver IC of claim 2, wherein the transmission control circuit is configured to generate the control signal based on a level of a control pin of the display driver IC.

5. The display driver IC of claim 1, further comprising:
a first latch signal generator configured to generate first latch signals based on a first latch control signal; and
a second latch signal generator configured to generate second latch signals based on a second latch control signal,
wherein first latches included in the first driver block are configured to latch corresponding ones of the deserialized pixel data groups in response to the first latch signals, second latches included in the second driver block are configured to latch corresponding ones of the deserialized pixel data groups in response to the second latch signals, and the first latch signal generator and the second latch signal generator are configured to alternately generate the first latch signals and the second latch signals.

6. The display driver IC of claim 5, wherein the transmission control circuit is configured to generate the first and second latch control signals based on configuration information included in the serial data packet.

7. The display driver IC of claim 5, wherein the transmission control circuit is configured to generate the first and second latch control signals based on a level of a control pin of the display driver IC.

8. A display system comprising:
a timing controller; and
a display driver integrated circuit (IC),
wherein the timing controller includes a transmission and high-speed interface block configured to generate a serial data packet having configuration information and pixel data groups and to transmit the serial data packet to the display driver IC, the configuration information indicating an order of the pixel data groups, each of the pixel data groups including pixel data for at least one pixel.

9. The display system of claim 8, wherein the display driver IC comprises:
a first driver block;
a second driver block; and
a transmission control circuit configured to deserialize the pixel data groups of the serial data packet and to alternate sending the deserialized pixel data groups to the first driver block and the second driver block based on a control signal associated with the configuration information.

10. The display system of claim 9, wherein the transmission control circuit is configured to send a first one of the deserialized pixel data groups to one of the first driver block and the second driver block based on the control signal.

11. The display system of claim 9, further comprising:
a first latch signal generator configured to generate first latch signals based on a first latch control signal; and
a second latch signal generator configured to generate second latch signals based on a second latch control signal,
wherein first latches included in the first driver block are configured to latch a corresponding one of the deserialized pixel data groups in response to the first latch signals, second latches included in the second driver block are configured to latch a corresponding one of the deserialized pixel data groups in response to the second latch signals, and the first latch signal generator and the second latch signal generator are configured to alternately generate the first latch signals and the second latch signals.

12. The display system of claim 11, wherein the transmission control circuit is configured to generate the first and second control signals based on the control signal associated with the configuration information.

13. The display system of claim 11, wherein the first latch signal generator is configured to generate one of the first latch signals before one of the second latch signals is generated.

14. The display system of claim 11, wherein the first latch signal generator is configured to generate one of the first latch signals after one of the second latch signals is generated.

15. The display system of claim 8, wherein the timing controller and the display driver IC are included in one of a television (TV), a digital TV (DTV), an internet protocol TV (IPTV), and a smart TV.

16. A display device comprising:
a controller configured to,
process pixel data groups of a received data packet in a desired order that changes based on a mode of the display device, each of the pixel data groups including pixel data for at least one pixel, and
output the processed pixel data groups from a first driver block and a second driver block in accordance with the desired order.

17. The display device of claim 16, wherein the controller includes a control pin that indicates the mode.

18. The display device of claim 16, wherein the pixel data includes configuration information to indicate the mode.

19. The display device of claim 17, wherein the controller generates first and second control signals that control an operation of a first latch signal generator and an operation of a second latch signal generator based on the level of the control pin.

20. The display device of claim 16, wherein if the mode is a high speed mode, the desired order is such that the controller is configured to alternately output the pixel data groups to the first driver block and the second driver block.
